(19) United States
(12) Patent Application Publication
(10) Pub. No.: US 2002/0020404 A1
(43) Pub. Date: Feb. 21, 2002

(54) Charcoal grill with anti-flare

(76) Inventors: Franck Viret, Lyon (FR); Franck Alvarez, Saint Etienne (FR); Eric Carrato, Chaussan (FR)

Correspondence Address: KRAMER LEVIN NAFTALIS & FRANKEL LLP, 919 THIRD AVENUE, NEW YORK, NY, 10022, US

(21) Appl. No.: 09/921,433

(22) Filed: Aug. 2, 2001

(30) Foreign Application Priority Data
Aug. 3, 2000 (FR) FR 00 10281

(51) Int. Cl. A47J 37/00

(52) U.S. Cl. 126/25 R; 126/25 B

(57) ABSTRACT

The present invention discloses a charcoal grill having a frame defining a fire chamber intended to receive the charcoal and a cooking gridiron mounted on the frame and extending at least partially above the fire chamber. An additional compartment is positioned vertically in the vicinity of the cooking gridiron and has a lower end designed to open into the fire chamber and interacting with a mobile sealing means, and an upper filling end for resupplying said additional compartment with charcoal.

FIELD OF THE INVENTION

The present invention relates to the field of grills, and more particularly to the field of charcoal grills.

### BACKGROUND INFORMATION

Charcoal grills are known having a frame, defining a fire chamber or hearth, intended to receive the charcoal, and a cooking gridiron mounted on the frame and extending at least partially above the fire chamber.

Traditionally, the lighting of the combustion chamber or hearth, using charcoal or any other solid fuel, represents a difficulty for the user. To solve this problem, the user resorts to other combustible substances or materials, such as flammable paper or wood, to bring the charcoal to a temperature at which it glows red, thus initiating its combustion as such. Be that as it may, the user must wait for the charcoal to become fully incandescent before proceeding or undertaking any cooking.

### SUMMARY OF THE INVENTION

The present invention relates to means enabling a charcoal grill to be lit easily.

According to the present invention, in addition to the fire chamber, or main combustion hearth, the grill has an additional or secondary compartment, whose capacity for solid fuel is preferably less than that of the fire chamber, said additional compartment, which is likewise adapted or designed for combustion of charcoal, being disposed vertically in the vicinity of the cooking gridiron, and designed to open into and communicate with the fire chamber. A sealing means, for example a flap, interacts with the lower end of the additional compartment, while the upper end of the latter allows the filling of the compartment and the resupply thereof with charcoal.

According to the invention, the additional compartment can therefore act as a hopper for the discontinuous feeding into the fire chamber of charcoal which has previously been brought to the point of incandescence, as and when required by said fire chamber.

By virtue of the invention, the upper compartment may be designed, particularly as regards shape and dimensions, to promote, in the manner of a chimney, effective and rapid lighting from below of the batch of charcoal which is placed therein, without any difficult or dangerous manipulation by the user or affecting the food placed on the cooking gridiron.

In an embodiment according to the invention, the additional compartment extends at one end of the cooking gridiron, and at least over part of its height above the level defined by the cooking gridiron.

In an embodiment according to the invention, the mobile sealing means is a mobile flap making it possible to seal or not seal the lower end of the additional compartment opening into the fire chamber.

In an embodiment according to the invention, the charcoal grill comprises an actuating mechanism for the mobile flap, accessible from outside the frame.

In an embodiment according to the invention, the actuating mechanism is associated with a locking means enabling the mobile flap to be held in the closed position if required.

In an embodiment according to the invention, the additional compartment, with the mobile flap in the closed position, constitutes a second fire chamber, which is substantially vertical and can be used individually or in combination with the main fire chamber, situated below the cooking gridiron.

In an embodiment according to the invention, the upper compartment is defined by vertical walls and the mobile flap.

In an embodiment according to the invention, the mobile flap in the closed position and one of the vertical walls form an acute angle in the bottom of the additional compartment.

Other features and advantages will also be apparent from the detailed description given below with reference to the attached drawing and by way of nonlimiting example.

### BRIEF DESCRIPTION OF THE DRAWINGS

FIGS. 1 and 2 show a charcoal grill according to the invention with an upper compartment whose mobile flap is, respectively, closed and open, seen from the side and in partial section;

FIGS. 3 and 4 show the actuating mechanism of the upper compartment of a grill according to the invention, which is shown without its feet and in an oblique view from left to right;

FIG. 5 shows a diagrammatic view of a charcoal grill according to the invention during filling; and

FIG. 6 shows a diagrammatic view of a charcoal grill according to the invention during the resupply of the fire chamber.

### DETAILED DESCRIPTION

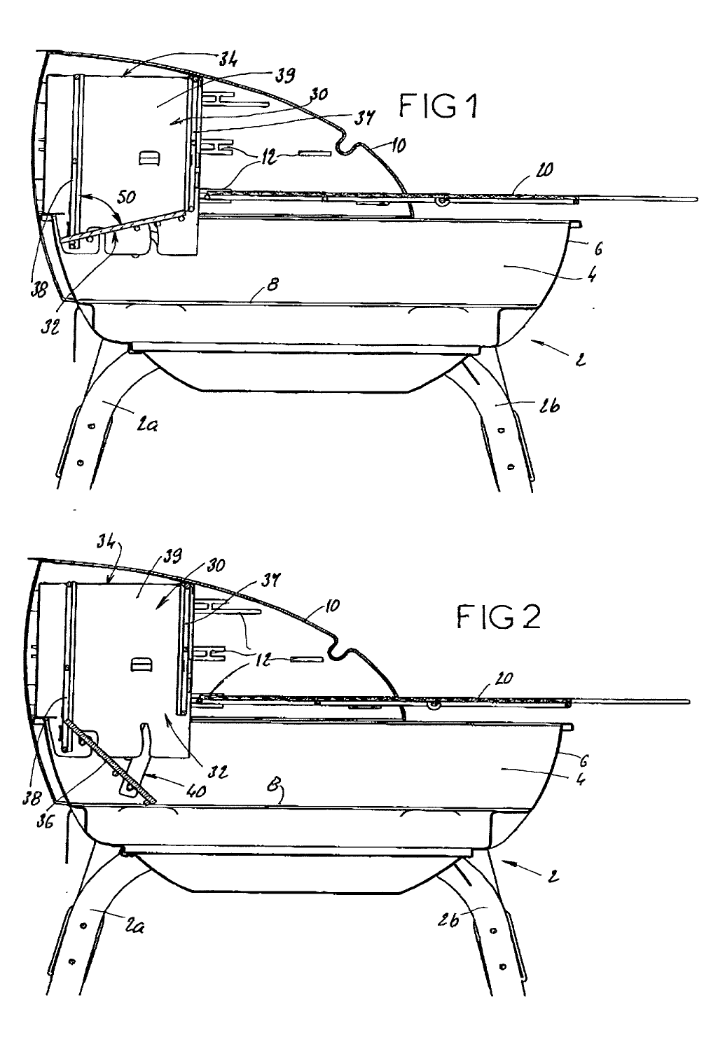

FIG. 1 shows an example of embodiment of the charcoal grill according to the invention. The charcoal grill has a frame 2 defining, internally, a fire chamber 4 or combustion hearth. The latter is defined with the aid of a peripheral wall 6 and a bottom 8 which may, for example, be removable and provide a support for the fuel. The frame 2 is likewise provided with feet 2a, 2b, and with a lateral wall 10 of the frame 2 and having horizontal guide ribs 12 intended for the positioning of a cooking gridiron 20. The latter may be positioned at different heights in the fire chamber 4.

Both FIG. 1 and FIG. 2 are sectional views and consequently show only a single lateral wall 10.

The frame 2 comprises an additional compartment 30, for receiving charcoal and undertaking the combustion thereof, positioned in the vicinity of the cooking gridiron 20. The additional compartment 30 has a sealable lower end 32, capable of communicating with the fire chamber 4, and an upper filling end 34 for resupplying said additional compartment 30 with charcoal. The additional compartment 30 extends substantially vertically on one side of the cooking gridiron 20, and extends, over at least part of its height, above the level defined by the cooking gridiron 20. The cooking surface is, consequently, defined first by the cooking gridiron 20 and secondly by the additional compartment 30.

The latter has a mobile flap 36 making it possible to seal or not seal the lower end 32 opening into the fire chamber 4. The additional compartment 30 is defined, at the front and at the rear respectively, by a vertical front wall 37 and a vertical rear wall 38. The vertical front wall 37 and rear wall 38, like the mobile flap 36, are for example made of a metal grid or gridiron.

The mobile flap 36 is articulated by any known means, for example on the vertical rear wall 38 or on additional lateral walls 39, made for example of metal, on each side of the additional compartment 30.

FIG. 2 shows the compartment 30 with the mobile flap 36 in the open position. Communication is thus provided between the additional compartment 30 and the fire chamber 4, the flap 36 in the oblique downward position causing the batch of charcoal to be guided toward the fire chamber 4.

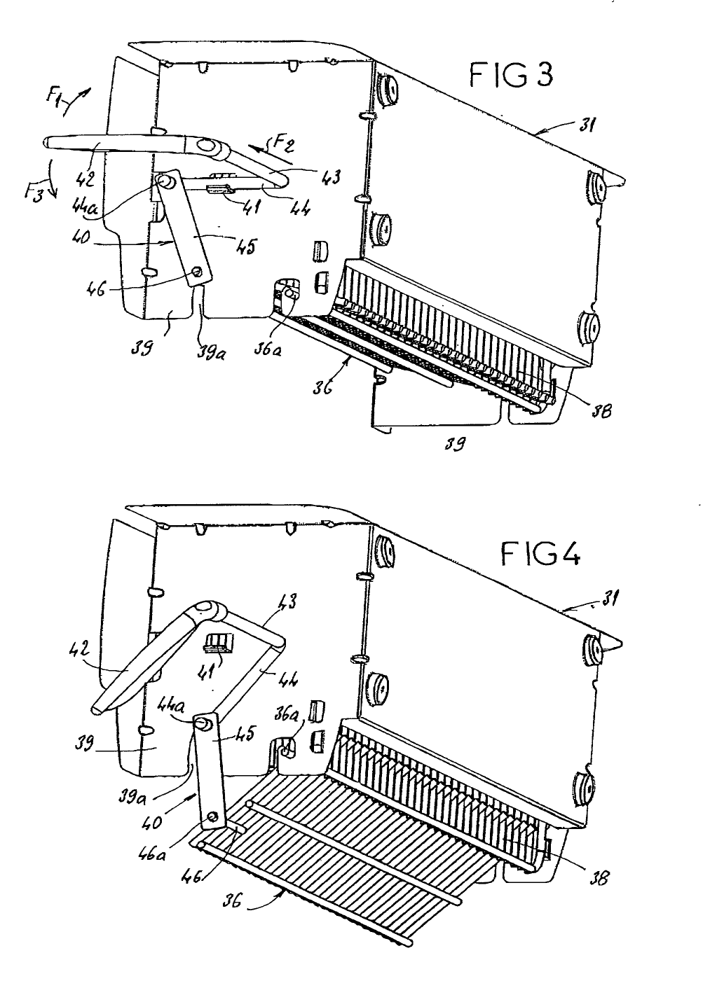

The charcoal grill according to the invention likewise comprises an actuating mechanism 40 for the mobile flap 36. This actuating mechanism 40 is accessible from outside the frame 2 (cf. FIGS. 3 to 6), as described below.

According to an example of an embodiment in accordance with the invention, the front wall 37 of the compartment 30 has a lesser height than the rear wall 38. The articulation of the mobile flap 36 relative to the front and rear walls 37, 38 is designed to produce, in the closed position of the mobile flap 36, an acute angle 50 between one of said walls 37, 38 and the plane defined by said mobile flap 36. This acute angle 50 is shown, for example, in FIG. 1, in which the rear wall 38 has a height greater than that of the front wall 37. The mobile flap 36 in the closed position and one of the vertical walls, in this case the rear wall 38, thus form the acute angle 50 in the bottom of the additional compartment 30.

Such a design of the bottom of this additional compartment 30 makes it possible to achieve optimum stacking of fuel (charcoal) with a view to initiating its combustion with the aid of a lighting device known per se. The charcoal grill according to the invention may, for example, be provided with a gas-fired lighting device allowing combustion of the charcoal to be initiated. The gas-fired lighting device is known and is not shown in the figures. It is thus possible to initiate combustion of the charcoal when the latter is still confined in the additional compartment 30, acting as a hopper, before introducing it into the fire chamber 4 by means of opening the mobile flap 36.

According to an example of use, the additional compartment 30 with the mobile flap 36 in the closed position (cf. FIG. 1) constitutes a second, substantially vertical fire chamber which can be used individually or in combination with the fire chamber 4 situated below the cooking gridiron 20. Such a use is particularly indicated if the charcoal grill is being used as a rotisserie. A spit may then be mounted, for example, between the lateral walls 10.

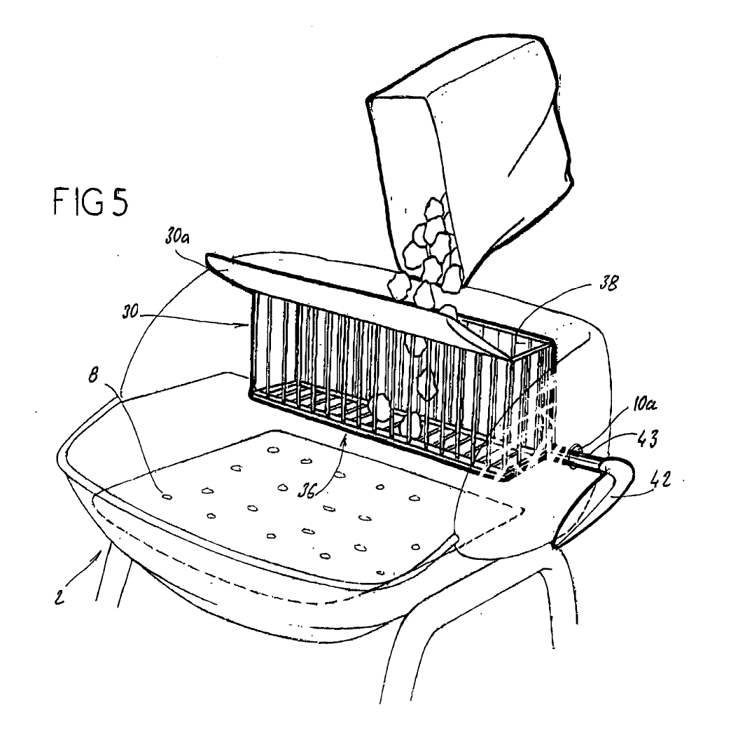

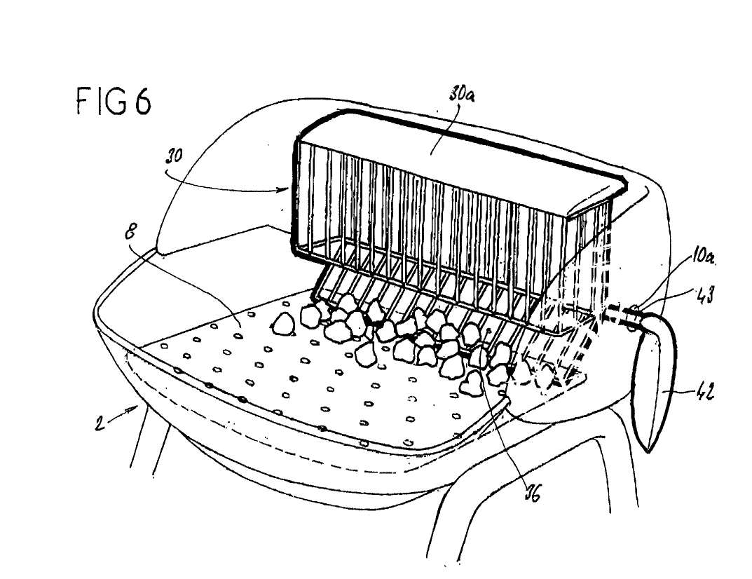

A lid 30a may likewise be provided on the additional compartment 30 or on the frame 2, so as to cover the filling aperture 34 of said compartment; cf. FIGS. 5 and 6.

The actuating mechanism 40 is illustrated in more detail in FIGS. 3 and 4. The actuating mechanism 40 is associated with a locking means 41 making it possible, if desired, to maintain the mobile flap 36 in the closed position, as can be seen in FIG. 3. The locking means 41 is produced, for example, with a localized deformation of a metal sheet forming one of the additional lateral walls 39.

The locking means 41 may likewise be provided with a hook solidly fixed to the additional lateral wall 39.

The actuating mechanism 40 comprises a gripping handle 42, accessible from outside the frame 2 and solidly fixed to an angled arm 43-44, which is itself connected to the mobile flap 36 via a connecting rod 45. The angled arm 43-44 possesses a first part 43 and a second part 44 which are perpendicular and connected, respectively, to the gripping handle 42 and to the connecting rod 45.

The first part 43 extends substantially perpendicularly to the longitudinal axis of the gripping handle 42 and the plane of extension defined by the additional lateral wall 39. The second part 44, like the connecting rod 45, extends substantially parallel to said lateral wall 39. The connecting rod 45 is, for example, provided with a drilled hole at each of its ends, in a manner such as to articulate it for rotation. This articulation is simply obtained by assembling a rod end 44a of the first part 44, curved perpendicularly thereto, and the end 46a of a rod 46 solidly fixed to the mobile flap 36, these two ends respectively passing through two corresponding drilled holes provided in the connecting rod 45.

When the mobile flap 36 is in the closed position, the second part 44 of the angled arm 43-44 rests on the locking means 41. When the user desires to open the mobile flap 36, and establish communication between the additional compartment 30 and the fire chamber 4, its first step is to pivot the gripping handle 42 upward (in the direction of the arrow F1 in FIG. 3) to release the second part 44 of the angled arm 43-44 from the locking means 41. The rotational guiding of the gripping handle 42, and consequently of the first part 43 of the angled arm 43-44, is ensured by the passage of said second part 44 in a corresponding aperture made in a lateral wall 10 of the frame 2. The user then exerts a tractive force on the gripping handle 42 in an axial direction of the first part 43 of the angled element 43-44, corresponding to the direction F2 shown in FIG. 3, so as to retract the locking means 41 completely. The user then pivots the gripping handle 42 downward, in the direction of the arrow designated with the reference F3 in FIG. 3, thus drawing downward the connecting rod 45 and the mobile flap 36 articulated on said connecting rod 45.

The displacement of the connecting rod 45, and also of the end of the rod 46 solidly fixed to the mobile flap 36, may advantageously be guided by a slot 39a made in the additional lateral wall 39. An additional rod 36a, solidly fixed to the mobile flap 36, is mounted for example in a corresponding aperture made in the lateral walls 39, so as to form a pivot axis for the mobile flap 36.

When the user wishes to reclose the mobile flap 36, he performs the same operations in the reverse order, in other words performing, with the gripping handle 42, movements successively opposite to those designated by the arrows F3, F2 and F1 respectively.

The actuating means 40 are located in a position illustrated in FIGS. 3 and 4, respectively, to keep the mobile flap 36 closed and open. When the mobile flap 36 is open, the latter rests, for example, on the bottom 8 of the fire chamber 4. Advantageously, when the mobile flap 36 seals the additional compartment 30, the latter does not come fully into abutment with, for example, the front wall 37, so as to permit slight upward pivoting of the gripping handle 42 in the direction of the arrow F1 and thus enables the second part 44 of the angled arm 43-44 to be freed from the locking means 41. The dimensions of the slot 39a are selected accordingly.

FIG. 5 shows, for example and diagrammatically, the additional compartment 30 provided with a closure lid 30a in the open position during a charcoal filling operation.

According to FIGS. 5 and 6, the lid is designed to pivot from the upper front edge of the compartment 30 about a horizontal axis from back (closed position) to front (oblique open position). This arrangement enables the charcoal to be guided toward the compartment 30, during filling of the latter, while providing protection for the food being cooked.

FIG. 6 diagrammatically illustrates the opening of the mobile flap 36, in other words following a displacement of the actuating means 40, and in the present case of the gripping handle 42 in the direction of the arrows F1, F2 and F3.

The additional compartment 30 is, for example, produced as a box removably mounted on or in the frame 2. The charcoal grill according to the invention may thus be designed and/or marketed on a modular basis, with the box as an accessory or optional module.

The charcoal grill according to the invention has an important advantage insofar as the fire chamber 4 may be continuously fed, for example for successive or prolonged cooking sessions, without it being necessary to resort to removal of the cooking gridiron 20.

Furthermore, the confinement of the fuel, in the present case charcoal, within the additional compartment 30 permits rapid lighting before said charcoal is distributed on the bottom 8 of the fire chamber 4.

Another not insignificant advantage lies in the production of a charcoal grill which can be used as a conventional charcoal grill with a single fire chamber 4 or as a rotisserie, in other words with a lateral and vertical fire chamber produced by the additional compartment 30.

Another use may be arranged, using two heat sources, the main source being provided by the fire chamber 4 and the other, secondary source being provided by the additional compartment 30.

What is claimed is:

1. A charcoal grill having:
a frame, defining a fire chamber intended to receive the charcoal; and
a cooking gridiron, mounted on the frame and extending at least partially above the fire chamber;
wherein an additional compartment is positioned vertically in the vicinity of the cooking gridiron and has a lower end designed to open into the fire chamber and interacting with a mobile sealing means, and an upper filling end for resupplying said additional compartment with charcoal.

2. The charcoal grill as claimed in claim 1, wherein the additional compartment extends at one end of the cooking gridiron, and at least over part of its height above the level defined by the cooking gridiron.

3. The charcoal grill as claimed in claim 2, wherein the mobile sealing means is a mobile flap making it possible to seal or not seal the lower end of the additional compartment opening into the fire chamber.

4. The charcoal grill as claimed in claim 3, which comprises an actuating mechanism for the mobile flap, accessible from outside the frame.

5. The charcoal grill as claimed in claim 4, wherein the actuating mechanism is associated with a locking means enabling the mobile flap to be held in a closed position if required.

6. The charcoal grill as claimed in claim 2, wherein the additional compartment, with the mobile sealing means in a closed position, constitutes a second fire chamber, which is substantially vertical and can be used individually or in combination with the main fire chamber, situated below the cooking gridiron.

7. The charcoal grill as claimed in claim 1, wherein the mobile sealing means is a mobile flap making it possible to seal or not seal the lower end of the additional compartment opening into the fire chamber.

8. The charcoal grill as claimed in claim 7, which comprises an actuating mechanism for the mobile flap, accessible from outside the frame.

9. The charcoal grill as claimed in claim 8, wherein the actuating mechanism is associated with a locking means enabling the mobile flap to be held in a closed position if required.

10. The charcoal grill as claimed in claim 7, wherein the additional compartment, with the mobile flap in a closed position, constitutes a second fire chamber, which is substantially vertical and can be used individually or in combination with the main fire chamber, situated below the cooking gridiron.

11. The charcoal grill as claimed in claim 1, wherein the additional compartment is defined by vertical walls and the mobile sealing means.

12. The charcoal grill as claimed in claim 11, wherein the mobile sealing means in a closed position and one of the vertical walls form an acute angle in the bottom of the additional compartment.

13. The charcoal grill as claimed in claim 1, wherein the additional compartment is a box removably mounted in the frame.

14. A charcoal grill comprising:
a frame defining a fire chamber for receiving charcoal; and
a cooking gridiron mounted on the frame and extending at least partially above the fire chamber;
wherein an additional compartment is positioned vertically adjacent to the cooking gridiron and having a lower end adapted to open into the fire chamber and via a mobile seal, the additional compartment also having an upper filling end for resupplying said additional compartment with charcoal.

15. A charcoal grill comprising:
a frame defining a fire chamber for receiving charcoal;
a cooking gridiron mounted on the frame and extending at least partially above the fire chamber; and
an additional compartment having a lower end, an upper filling end and a mobile seal;
wherein the additional compartment is positioned adjacent to the cooking gridiron, and the lower end of the additional compartment opens into the fire chamber via operation of the mobile seal.

16. The charcoal grill as claimed in claim 15 wherein the upper filling end of the additional compartment is adapted to receive charcoal for resupplying the additional compartment.

17. The charcoal grill as claimed in claim 15, wherein the additional compartment is disposed at an end of the cooking gridiron and extends at least partially above a height level defined by a surface of the cooking gridiron.

18. The charcoal grill as claimed in claim 15, wherein the mobile seal is a mobile flap positioned in one of a seal position and a no seal position for the lower end of the additional compartment opening into the fire chamber.

19. The charcoal grill as claimed in claim 18, further comprising an actuating mechanism connected to the mobile flap, the actuating mechanism being accessible from outside the frame.

20. The charcoal grill as claimed in claim 19, wherein the actuating mechanism is associated with a locking means enabling the mobile flap to be held in the seal position.

21. The charcoal grill as claimed in claim 15, wherein the additional compartment, with the mobile seal in a seal position, forms a second fire chamber which is substantially vertical and can be used individually or in combination with the fire chamber.

22. The charcoal grill as claimed in claim 15, wherein the additional compartment comprises at least one vertical wall and wherein the mobile seal is a mobile flap.

23. The charcoal grill as claimed in claim 22, wherein when the mobile flap is in a seal position, the mobile flap forms an acute angle with respect to the at least one vertical wall.

24. The charcoal grill as claimed in claim 15, wherein the additional compartment is removably mounted in the frame.
